(19) United States
(12) Patent Application Publication
(10) Pub. No.: US 2025/0124717 A1
(43) Pub. Date: Apr. 17, 2025

(54) VIDEO RECORDING METHOD ACCORDING TO AN AUTONOMOUS DRIVING CONTROL AUTHORITY AND A SYSTEM FOR THE SAME

(71) Applicants: HYUNDAI MOTOR COMPANY, Seoul (KR); KIA CORPORATION, Seoul (KR)

(72) Inventor: Dong Hyuk Jeong, Hwaseong-si (KR)

(73) Assignees: HYUNDAI MOTOR COMPANY, Seoul (KR); KIA CORPORATION, Seoul (KR)

(21) Appl. No.: 18/909,477

(22) Filed: Oct. 8, 2024

(30) Foreign Application Priority Data
Oct. 16, 2023 (KR) 10-2023-0137650

(51) Int. Cl. G06V 20/56; B60R 11/04; B60W 30/09; B60W 50/14; B60W 60/00

(52) U.S. Cl. CPC G06V 20/56; B60R 11/04; B60W 30/09; B60W 50/14; B60W 60/007

(57) ABSTRACT

A method of recording videos based on control authority over autonomous driving includes operating a vehicle in any one of two or more autonomous driving modes classified according to a ratio of control authority of a driver to that of an autonomous driving controller. The method also includes setting areas to be scanned in two or more directions outside the vehicle and determining whether a dangerous event occurs in each of the areas to be scanned. The method further includes storing videos of one of the areas when it is determined that the dangerous event has occurred in the area, determining whether there has been a transition between the autonomous driving modes to avoid the dangerous event, and storing data on responses to risks corresponding to the current autonomous driving mode along with the videos when there has been the transition between the autonomous driving modes.

### CROSS-REFERENCE TO RELATED APPLICATION

The present application claims the benefit of and priority to Korean Patent Application No. 10-2023-0137650, filed on Oct. 16, 2023, the entire contents of which are hereby incorporated herein by this reference.

### TECHNICAL FIELD

The present disclosure relates to a method of recording videos based on control authority over autonomous driving and a system therefor.

### BACKGROUND

The statements in this section merely provide background information related to the present disclosure and may not constitute prior art.

With the recent development of automobile technology, the spread of self-driving cars that are capable of operating themselves on their own without a driver's intervention is expected to progress rapidly.

The aforementioned self-driving car refers to a car that can drive itself by controlling various sensors and control systems with artificial intelligence, and is also referred to by various terms such as an autonomous car, a driverless car, and a robotic car.

Through such self-driving cars, it is not only possible to prevent accidents due to a mistake made by a careless driver or aggressive driving, but it is also possible for unlicensed people, blind people, and minors to freely use vehicles. However, research on the safety of self-driving cars is insufficient, and, as a result, when self-driving cars are not controlled and malfunction, it can have a fatal impact on occupants thereof, surrounding vehicles, and pedestrians. Therefore, in some cases, driving by a driver's control is safer than autonomous driving.

Accordingly, self-driving cars may be equipped with a system to immediately transfer control of a vehicle to a driver when the driver wants to operate the vehicle or when an error occurs in an autonomous driving system. In addition, when control of a vehicle is transferred to a driver who has grown inattentive while not controlling the vehicle himself/herself, it may lead to an accident. Thus, it is desirable to find a way to gradually transfer control of a vehicle through cooperation between a driver and an autonomous driving system.

Consequently, the standards and definition for each stage of autonomous driving are as shown in the table in FIG. 1, which is in accordance with the autonomous driving standard “J3016” of SAE International.

Therefore, according to many techniques for switching control of a vehicle proposed due to the above-mentioned issues, control of the vehicle is switched according to the steps defined in the table in FIG. 1.

In addition, as functions related to autonomous driving have been rapidly applied to vehicles in recent days, as shown in FIG. 2, radars and LIDARs have been applied to vehicles to scan not only the front and rear but also the front side and rear side, and cameras for sensing or viewing, such as cameras for perceiving the front lane, cameras to assist rear parking, and multi-channel cameras that can view even the rear side and the front side, have also been applied to vehicles.

Through such a self-driving technology, it is possible to give a warning signal to a driver or intervene in the operation of a vehicle when there is a risk of an accident, not only while the vehicle is running in an autonomous driving mode but also while it is being driven by the driver's control.

However, when warning the driver or intervening in the operation of the vehicle in a dangerous situation while the vehicle is being driven in an autonomous driving mode or by the driver's control, the situation at the time is not properly recorded. Therefore, there is no way to respond appropriately when a customer claim arises regarding autonomous driving functions or warning and intervention functions.

In addition, the memory capacity may not be sufficient to store all videos recorded in multiple channels.

The information included in this Background section is intended merely to enhance understanding of the general background of the present disclosure. Therefore, the Background section should not be taken as an acknowledgement or any form of suggestion that this information forms the prior art already known to a person having ordinary skill in the art to which the present disclosure pertains.

### SUMMARY

Embodiments of the present disclosure are aimed at resolving the above-described problems.

Embodiments of the present disclosure provide a method of recording videos based on control authority over autonomous driving and a system therefor, where, based on control authority over autonomous driving, information on a warning signal provided by an autonomous driving controller, information on autonomous driving, and videos obtained by related sensors and cameras are stored in the storage space of a built-in cam according to conditions, the situations before and after the time when control authority is transferred are mainly recorded, and videos are recorded in a manner tailored to the current control authority when control authority has been transferred.

According to an embodiment of the present disclosure, a method of recording videos is provided. The method includes determining, by a controller, that a preset function of an autonomous driving control is performed for avoiding a preset dangerous event. The method also includes storing, by the controller, a video around the vehicle and data related to the function in association with the video based on the determining of the preset function being performed.

The method may further include setting, by the controller, at least one area to be scanned outside the vehicle and determining that a preset event occurs in the at least one area, and storing a video of the at least one area based on a determination that the preset dangerous event has occurred.

The controller may be configured to control the vehicle in a full-driving-automation mode where the controller fully exercises control of the vehicle.

The preset function may include warning a driver of the preset dangerous event.

The data may include details of the warning and sensing results associated with the preset dangerous event.

The method may further include performing, by controller, an intervening control to avoid the preset dangerous event while the vehicle is controlled in a driver driving mode, and storing, by the controller, a video around the vehicle at the intervening control, and status information of the vehicle and data related to the intervening control in association with the video.

The data related to the intervening control may include information on having given the driver the warning of the dangerous event.

The status information may include any one or a combination of information obtained by at least one LIDAR, information obtained by at least one radar, or information obtained by at least one ultrasonic sensor.

The method may include storing, by the controller, details of control by the controller and sensor data while the vehicle is controlled in an autonomous driving mode, and a video around the vehicle captured during the autonomous driving mode.

The preset function may include warning a driver of the preset dangerous event while the vehicle is controlled in an autonomous driving mode by the controller.

According to another embodiment of the present disclosure, a system for recording videos based on control authority over autonomous driving is provided. The system includes two or more sensing sensor modules configured to set at least one area to be scanned outside the vehicle, a camera configured to obtain videos around the vehicle. The system also includes a controller configured to determine that a preset function of an autonomous driving control is performed for avoiding a preset dangerous event. The system additionally includes a storage unit configured to store the videos obtained by the camera and data related to the function in association with the video under control of the controller.

In a system of at least one embodiment of the present disclosure, the controller is configured to determine that a preset event occurs in the at least one area, and the controller is further configured to store a video of the at least one area in the storage unit based on a determination of the controller that the preset dangerous event has occurred.

In a system of at least one embodiment of the present disclosure, the controller is further configured to control the vehicle in a full-driving-automation mode where the controller fully exercises control of the vehicle.

In a system of at least one embodiment of the present disclosure, the preset function comprises warning a driver of the preset dangerous event.

In a system of at least one embodiment of the present disclosure, the data comprises details of the warning and sensing results associated with the preset dangerous event.

In a system of at least one embodiment of the present disclosure, the controller is further configured to perform an intervening control to avoid the preset dangerous event while the vehicle is controlled in a driver driving mode, and the controller is further configured to store in the storage unit a video around the vehicle at the intervening control, and status information of the vehicle and data related to the intervening control in association with the video.

In a system of at least one embodiment of the present disclosure, the data related to the intervening control includes information on having given the driver the warning of the dangerous event.

In a system of at least one embodiment of the present disclosure, the status information includes any one or a combination of information obtained by at least one LIDAR, information obtained by at least one radar, of information obtained by at least one ultrasonic sensor.

In a system of at least one embodiment of the present disclosure, the controller is further configured to store in the storage unit details of control by the controller and sensor data while the vehicle is controlled in an autonomous driving mode, and a video around the vehicle captured during the autonomous driving mode.

In a system of at least one embodiment of the present disclosure, the preset function includes warning a driver of the preset dangerous event while the vehicle is controlled in an autonomous driving mode by the controller.

Through the method of recording videos based on control authority over autonomous driving and the system therefor according to embodiments of the present disclosure, it may be possible to give a driver warning of dangerous situations while a vehicle is driving in any one of two or more autonomous driving modes and to record data on the status and the operation of the vehicle at the time when driving control has been transferred by the driver or a controller along with videos.

The methods and apparatuses of the present disclosure have other features and advantages which should be apparent from or are set forth in more detail in the accompanying drawings and the following Detailed Description, which together serve to explain certain principles of the present disclosure.

### BRIEF DESCRIPTION OF THE DRAWINGS

FIG. 1 shows a table summarizing the authority of a driver and a system for each stage of autonomous driving according to the autonomous driving standard of SAE International.

FIG. 2 shows how radars, LIDARs, and cameras of a self-driving car work.

FIG. 3 is a block diagram for showing the components of the system for autonomous driving to which the method of recording videos based on control authority over autonomous driving according to an embodiment of the present disclosure is applied.

FIGS. 4A and 4B are flowcharts for illustrating the method of recording videos based on control authority over autonomous driving according to an embodiment of the present disclosure.

It should be understood that the accompanying drawings are not necessarily to scale, presenting a somewhat simplified representation of various features illustrative of the basic principles of the present disclosure. The specific design features of the present disclosure as included herein, including, for example, specific dimensions, orientations, locations, and shapes, will be determined in part by the particularly intended application and use environment.

In the figures, the same reference numerals refer to the same or equivalent parts of the present disclosure throughout the several figures of the drawing.

### DETAILED DESCRIPTION

Because various changes can be made to the present disclosure and a range of embodiments can be made for the present disclosure, specific embodiments are illustrated and described in the drawings. However, this is not intended to limit the present disclosure to the specific embodiments, and it should be understood that the present disclosure includes all changes, equivalents, and substitutes within the technology and the scope of the present disclosure.

The terms “module” and “unit” used in the present disclosure are merely used to distinguish the names of components, and should not be interpreted as assuming that the components are necessary physically or chemically separated or can be so separated.

Terms containing ordinal numbers such as “first” and “second” may be used to describe various components, but the components are not limited by the terms. The above-mentioned terms are merely used to distinguish one component from another component, and the order therebetween can be determined by the context in the descriptions thereof, not by such names.

The expression “and/of” is used to include all possible combinations of multiple items being addressed. For example, by “A and/or B,” all three possible combinations are meant: “A,” “B,” and “A and B.”

When a component is said to be “coupled” or “connected” to another component, it means that the component may be directly coupled or connected to the other component or there may be one or more other components therebetween.

When a component, device, module, element, or the like of the present disclosure is described as having a purpose or performing an operation, function, or the like, the component, device, or element should be considered herein as being “configured to” meet that purpose or perform that operation or function.

The terms used herein are merely used to describe specific embodiments and are not intended to limit the present disclosure. Expressions in the singular form include the meaning of the plural form unless the expressions clearly mean otherwise in the context. In the present disclosure, expressions such as “comprise,” “include,” or “have,” are intended to indicate the presence of features, numbers, steps, operations, components, parts, or combinations thereof described herein, and should not be understood as precluding the possibility of the presence or the addition of one or more other features, numbers, steps, operations, components, parts, or combinations thereof.

Unless otherwise defined, all terms used herein, including technical or scientific terms, have meanings commonly understood by a person having ordinary skill in the art to which the present disclosure pertains. Terms defined in commonly used dictionaries should be interpreted as having meanings consistent with the meanings that the terms have in the context of the relevant technology, and should not be interpreted in an ideal or overly formal sense unless explicitly defined in the present disclosure.

In addition, a module, a unit, a control unit, a control device, or a controller is merely a term widely used to name devices for controlling a certain function, and do not mean a generic function unit. For example, devices with such names may include a communication device that communicates with other controllers or sensors to control a certain function, a computer-readable recording medium that stores an operating system, logic instructions, input/output information, etc., and one or more processors that perform operations of determination, calculation, making decisions, etc. required to control the function.

The processor may include a semiconductor integrated circuit and/or electronic devices that carry out operations of at least one of comparison, determination, calculation, and making decisions to perform a programmed function. For example, the processor may be any one or a combination of a computer, a microprocessor, a CPU, an ASIC, and an electronic circuit such as circuitry and logic circuits.

Examples of a computer-readable recording medium (or simply called a memory) may include all types of storage devices for storing data that can be read by a computer system. For example, examples of a computer-readable recording medium may include at least one of a memory such as a flash memory, a hard disk, a micro memory, and a card memory, e.g., a secure digital card (SD card) or an eXtream digital card (XD card), and a memory such as a random access memory (RAM), a static ram (SRAM), a read-only memory (ROM), a programmable ROM (PROM), an electrically erasable PROM (EEPROM), a magnetic RAM (MRAM), a magnetic disk, or an optical disk.

Such a recording medium may be electrically connected to the processor, and the processor may load and write data from the recording medium. The recording medium and the processor may be integrated or may be physically separate devices.

Hereinafter, with reference to the accompanying drawings, a method of recording videos based on control authority over autonomous driving and a system therefor according to embodiments of the present disclosure is described.

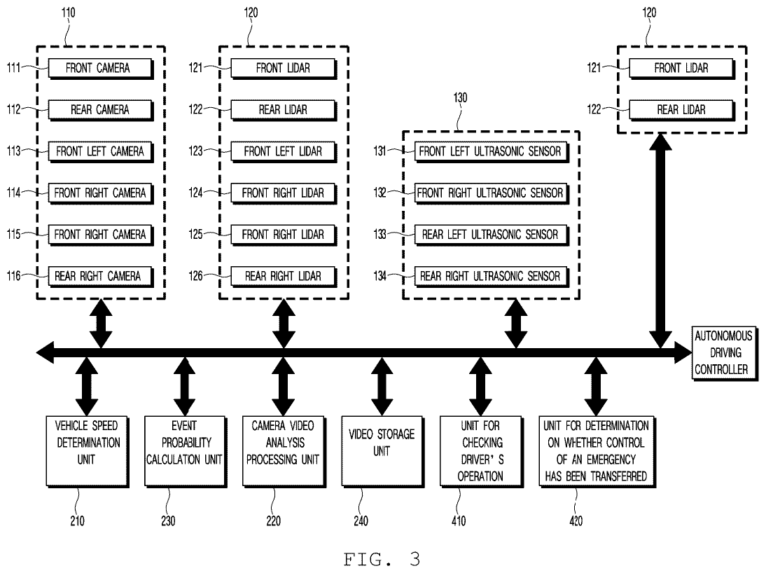

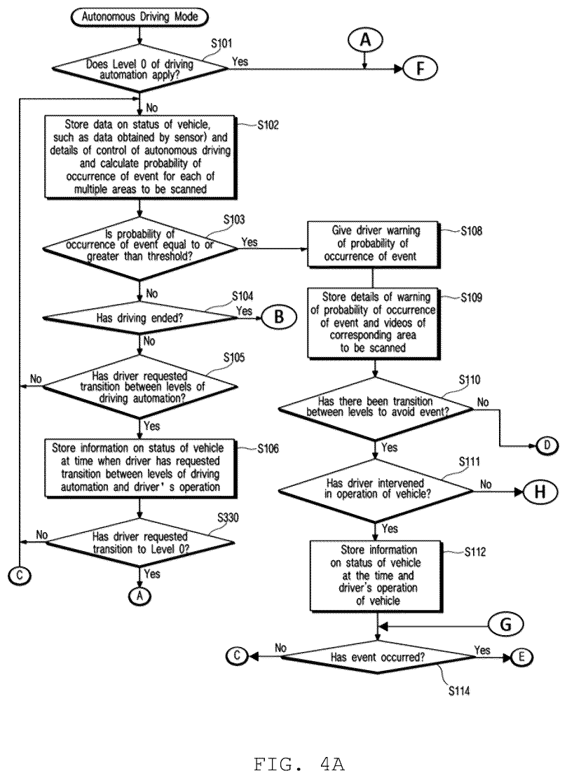

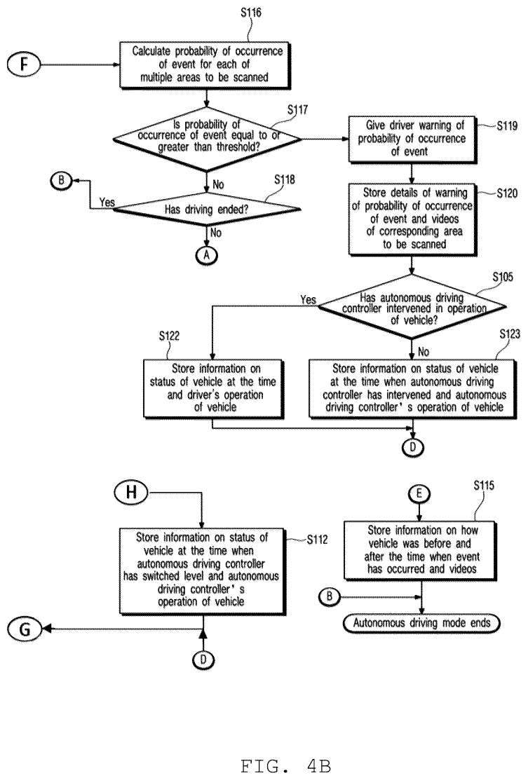

FIG. 3 is a block diagram for showing the components of a system for autonomous driving configured to perform a method of recording videos based on control authority over autonomous driving according to an embodiment of the present disclosure. FIGS. 4A and 4B are flowcharts for illustrating a method of recording videos based on control authority over autonomous driving according to an embodiment of the present disclosure.

As shown in FIG. 3, a system for autonomous driving according to an embodiment of the present disclosure may include a camera module or device 110 including a plurality of cameras built into an autonomous vehicle. The system may also include a light detection and ranging or laser imaging, detection, and ranging (LIDAR or LiDAR) module or device 120, including a plurality of LIDARs or LiDARs, that scan the direction in which the camera of the camera module or device 110 is looking. The system may additionally include a radar module or device 140 including a plurality of radars placed at the front or rear of the vehicle. The system may further include an ultrasonic sensor module or device 130 including a plurality of ultrasonic sensors placed on the side of the vehicle. The system may also include a vehicle speed determination unit 210 that determines whether the ultrasonic sensor module or device 130 operates based on the driving speed of the vehicle. The system may additionally include a camera video analysis processing unit 220 that analyzes the videos obtained by the camera module or device 110. The system may further include an event probability calculation unit 230 that calculates the probability of occurrence of an event based on the video analyzed by the camera video analysis processing unit 220 or data output by the radar module or device 140, the ultrasonic sensor module or device 130, or the LIDAR module or device 120. The system may further still include a video storage unit 240 that records and stores the videos obtained by the camera of the camera module or device 110 looking at a direction in which an event is highly likely to occur based on the probability of occurrence of an event calculated by the event probability calculation unit 230. The system may also include an autonomous driving controller 300 that calculates the probability of occurrence of an event based on the data output by the radar module or device 140, the ultrasonic sensor module or device 130, or the LIDAR module or device 120, independently of the operation of the event probability calculation unit 230, and allows the vehicle to drive on a path with the lowest probability of occurrence of the event while storing videos obtained by the camera of the camera module or device 110 looking at a path with the highest probability of occurrence of the event through the video storage unit 240.

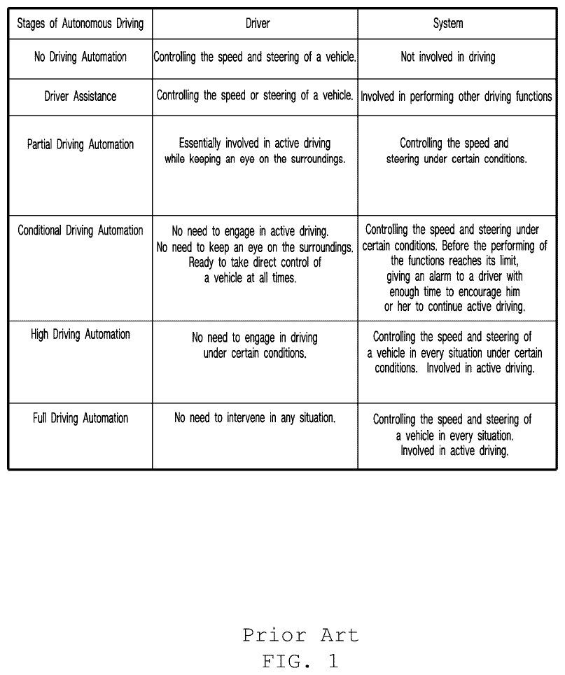

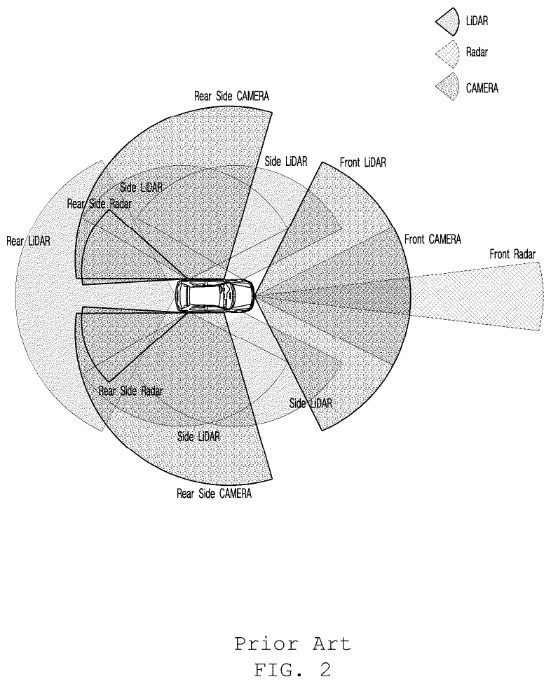

A unit for checking a driver's operation 410 may check how the driver is operating a vehicle. Further, a unit for determination on whether control of an emergency has been transferred 420 may determine whether the driver or the autonomous driving controller 300 of a running vehicle to which one of the six levels of driving automation as shown in FIG. 1 applies takes control in an emergency situation or a situation where an event is likely to occur and switches the current autonomous driving mode to another one.

Therefore, the autonomous driving controller 300 may further perform a function to store information obtained by the unit for checking a driver's operation 410 and the unit for determination on whether control of an emergency has been transferred 420 in the video storage unit 240.

The radar module or device 140, the ultrasonic sensor module or device 130, or the LIDAR module or device 120 may be collectively referred to as a sensing sensor module or sensing sensor device.

In addition, the vehicle speed determination unit 210 may determine the current driving speed of the vehicle through a vehicle speed sensor (not shown), and may operate the ultrasonic sensor module or device 130 when the driving speed of the vehicle is lower than or equal to a preset threshold (e.g., 10 km/h).

The camera module or device 110 may include a front camera 111, a rear camera 112, a front left camera 113, a front right camera 114, a rear left camera 115, and a rear right camera 116 to prevent blind spots when looking out of a vehicle.

The LIDAR module or device 120 may also include a front lidar 121, a rear lidar 122, a front left lidar 123, a front right lidar 124, a rear left lidar 125, and a rear right lidar 126 to scan the directions the cameras 111 to 116 of the camera module or device 110 are looking at.

The radar module or device 140 may include a front radar 141 that scans the front and a rear radar 142 that scans the rear, and, although not shown, the rear radar 142 may desirably include a rear left radar that scans the rear left side of a vehicle and a rear right radar that scans the rear right side of the vehicle.

The ultrasonic sensor module or device 130 may include a front left ultrasonic sensor 131, a front right ultrasonic sensor 132, a rear left ultrasonic sensor 133, and a rear right ultrasonic sensor 134. The ultrasonic sensor module or device 130 may operate under the control of the vehicle speed determination unit 210 when the vehicle is traveling at a low speed.

In addition, when a vehicle is driving in an autonomous driving mode, the autonomous driving controller 300 may further perform a function to store data obtained by the sensing sensor module or device and data resulting from the operations for controlling a vehicle in the video storage unit 240.

It should be noted that the modules (or devices) may each include a memory in which a program for performing a corresponding module's function is stored and a processor for executing the program and that the memories of the modules may be integrated into one or more memories and the processors thereof may be integrated into one or more processors.

Hereinafter, with reference to FIGS. 4A and 4B, a process of operating the system for autonomous driving to which the method of recording videos based on control authority over autonomous driving according to an embodiment of the present disclosure is applied is described.

In an operation S101, it may be determined whether Level 0 of driving automation applies to a running vehicle in question. In other words, as shown in the table in FIG. 1, Level 0 of driving automation corresponds to a no-driving-automation mode where a driver fully exercises control of a vehicle.

Therefore, when the vehicle is determined to be driving in an autonomous driving mode corresponding to Levels 1 to 5 of driving automation other than the no-driving-automation mode in the operation S101, the process may proceed to an operation S102 in which data on the status of the vehicle (including data obtained by a sensor) and the details of control of the autonomous driving controller 300 may be stored, and the probability of occurrence of an event may be calculated for each of multiple areas to be scanned outside the vehicle.

In an operation S103, it may be determined whether the probability of occurrence of an event calculated at S102 is equal to or greater than a preset threshold. When the probability is determined to be less than the preset threshold (a less hazardous situation), the process may proceed to an operation S104 in which it may be determined whether the driving has ended.

When it is not determined that the driving has ended (e.g., when it is determined that the driving has not ended) in the operation S104, the process may proceed to an operation S105 in which it may be determined whether the driver has requested the transition between the levels of driving automation.

When it is not determined that the driver has requested the transition (e.g., when it is determined that the driver has requested the transition) in the operation S105, the process may return to the operation S102, and the above-described process may be repeated.

In contrast, when it is determined that the driver has requested the transition in the operation S105, the process may proceed to an operation S106 in which information on the status of the vehicle at the time when the driver has made the request and the driver's operation may be stored.

Thereafter, in an operation S107, it may be determined whether the driver has requested the transition to Level 0 of driving automation, i.e., the no-driving-automation mode. When it is determined that the driver has requested the transition from the current level, which is one of Levels 1 to 5, to another level, which is one of Levels 1 to 5, other than the no-driving-automation mode, the transition to the level may take place. The process may then return to the operation S102, and the above-described process may be repeated.

When the probability of occurrence of an event is determined to be equal to or greater than a preset threshold (a highly hazardous situation) in the operation S103, the process may proceed to an operation S108 in which the driver may receive a warning signal about the probability of occurrence of an event in the form of a voice message, a buzzer sound, a text message, etc.

Then, in an operation S109, the details of the warning signal about the probability of occurrence of an event provided to the driver in the operation S108 and the videos obtained by a camera looking at an area in which an event is highly likely to occur may be stored.

In an operation S110, it may be determined whether there has been the transition between the levels of driving automation to avoid the occurrence of an event. When it is determined in the operation S110 that there has been such a transition, the process may proceed to an operation S111 in which it may be determined whether the level transition is based on the driver's determination or the independent determination of the autonomous driving controller 300.

In an embodiment, in autonomous driving modes corresponding to Levels 1 to 3, the autonomous driving controller 300 may assist or cooperate with the driver, and, when a driver is missing the golden time to avoid an event, the autonomous driving controller 300 may switch to Level 4 or 5 to use the golden time during which the driver could not react.

On the other hand, when a level transition does not occur due to the intervention of the autonomous driving controller 300 as described above, the level transition occurs due to the intervention of a driver, and, the level transition to Level 0 or 1 may take place when the driver suddenly takes control of a vehicle while the vehicle is driving in an autonomous driving mode corresponding to Level 4 or 5.

Therefore, at the operation S111, it may be determined whether the driver has intervened in the operation of the vehicle, and, when it is determined that the driver has intervened therein, the process may proceed to an operation S112 in which various information on the driver's operation of the vehicle and information on the status of the vehicle at the time may be stored.

In addition, in the operation S111, it may be determined whether the driver has intervened in the operation of the vehicle, and, when it is determined that the autonomous driving controller 300, not the driver, has intervened therein, the process may proceed to an operation S113 in which information on operation of the vehicle by the autonomous driving controller 300 may be stored along with information on the status of the vehicle at the time.

Thereafter, it may be determined whether an event has occurred at an operation S114, and, when it is not determined that an event has occurred, the process may return to the operation S102, and the above-described process may be repeated. In contrast, when it is determined that an event has occurred at the operation S114, the process may proceed to an operation S115 in which information on how the vehicle was before and after the time when the event has occurred and the videos (videos obtained by a camera looking at an area where the event has occurred) may be stored.

When it is determined that Level 0 of driving automation applies to the vehicle at the operation S101, the process may proceed to an operation S116 in which the probability of occurrence of an event may be calculated for each of multiple areas to be scanned. In addition, in an operation S117, it may be determined whether the probability of occurrence of an event calculated in the operation S116 is equal to or greater than a preset threshold, and, when the probability is determined to be less than the preset threshold (a less hazardous situation), the process may proceed to an operation S118 in which it may be determined whether the driving has ended.

When it is not determined that the driving has ended (e.g., when it is determined that the driving has not ended) in the operation S104, the process may return to the operation S116.

On the other hand, when the probability of occurrence of an event is determined to be equal to or greater than a preset threshold (a highly hazardous situation) in the operation S117, the process may proceed to an operation S119 in which the driver may receive a warning signal about the probability of occurrence of an event in the form of a voice message, a buzzer sound, a text message, etc.

Then, in an operation S120, the details of the warning signal about the probability of occurrence of an event provided to the driver in the operation S119 and the videos obtained by a camera looking at an area in which an event is highly likely to occur may be stored.

Thereafter, in an operation S121, it may be determined whether the autonomous driving controller 300 has intervened in the operation of the vehicle to avoid the occurrence of an event.

In an embodiment, because the vehicle is currently driving in the no-driving-automation mode where the driver is fully exercising control of the vehicle, when the driver is missing the golden time to avoid an event, the autonomous driving controller 300 may switch to Level 4 or 5 to use the golden time during which the driver could not react.

Accordingly, in the operation S121, it may be determined whether the autonomous driving controller 300 has intervened in the operation of the vehicle, and, when it is determined that only the driver has intervened therein, the process may proceed to an operation S122 in which various information on the driver's operation of the vehicle and information on the status of the vehicle at the time may be stored.

In addition, when the autonomous driving controller 300 is determined to have intervened in the operation of the vehicle in the operation S121, the process may proceed to an operation S123 in which information on operation of the vehicle by the autonomous driving controller 300 may be stored along with information on the status of the vehicle at the time.

Example embodiments of the present disclosure have been shown and described, but the present disclosure is not limited to the specific embodiments described above. It should be understood by those having ordinary skill in the art that various modifications can be made to the present disclosure within the gist of the present disclosure claimed in the appended claims, and such modifications should be understood as being included in the present disclosure.

The foregoing description of the specific embodiments of the present disclosure have been presented for the purposes of illustration and description. The description is not intended to be exhaustive or to limit the present disclosure to the precise forms disclosed, and many modifications and variations are possible in light of the above-described teachings. The embodiments were chosen and described to explain certain principles of the present disclosure and their practical application, to enable others having ordinary skill in the art to make and utilize the various embodiments of the present disclosure, as well as various alternatives and modifications thereof. It is intended that the scope of the present disclosure be defined by the claims appended hereto and their equivalents.

What is claimed is:

1. A method of recording videos for a vehicle, the method comprising:
determining, by a controller, that a preset function of an autonomous driving control is performed for avoiding a preset dangerous event; and
storing, by the controller, i) a video of surroundings of the vehicle and ii) data related to the preset function in association with the video in response to determining that the preset function is performed.

2. The method of claim 1, further comprising setting, by the controller, at least one area to be scanned outside the vehicle,
wherein:
determining that the preset dangerous event occurs comprises determining that the preset dangerous event occurs in the at least one area; and
storing the video comprises storing a video of the at least one area in response to determining that the preset dangerous event has occurred.

3. The method of claim 1, wherein the controller is configured to control the vehicle in a full-driving-automation mode where the controller fully exercises control of the vehicle.

4. The method of claim 1, wherein the preset function includes giving a driver a warning of the preset dangerous event.

5. The method of claim 4, wherein the data includes details of the warning and sensing results associated with the preset dangerous event.

6. The method of claim 1, further comprising:
performing, by the controller, an intervening control to avoid the preset dangerous event while the vehicle is controlled in a driver driving mode; and
storing, by the controller, i) a video of surroundings of the vehicle at the intervening control and ii) status information of the vehicle and data related to the intervening control in association with the video.

7. The method of claim 6, wherein the data related to the intervening control includes information on having given the driver a warning of the preset dangerous event.

8. The method of claim 6, wherein the status information includes one or more of i) information obtained by at least one light detection and ranging (LIDAR) module, ii) information obtained by at least one radar, or iii) information obtained by at least one ultrasonic sensor.

9. The method of claim 1, further comprising storing, by the controller, i) details of the autonomous driving control and sensor data while the vehicle is controlled in an autonomous driving mode and ii) a video of surroundings of the vehicle captured during the autonomous driving mode.

10. The method of claim 1, wherein the preset function includes warning a driver of the preset dangerous event while the vehicle is controlled in an autonomous driving mode.

11. A system for recording videos for a vehicle, the system comprising:
two or more sensing sensor modules configured to set at least one area to be scanned outside the vehicle;
a camera configured to obtain a video of surrounds of the vehicle;
a controller configured to determine that a preset function of an autonomous driving control is performed for avoiding a preset dangerous event; and
a storage unit configured to store the video obtained by the camera and data related to the preset function in association with the video under control of the controller.

12. The system of claim 11, wherein the controller is configured to:
determine that the preset dangerous event occurs in at least one area set to be scanned outside the vehicle; and
store, in the storage unit, a video of the at least one area in the storage unit in response to determining that the preset dangerous event has occurred.

13. The system of claim 11, wherein controller is further configured to control the vehicle in a full-driving-automation mode where the controller fully exercises control of the vehicle.

14. The system of claim 11, wherein the preset function includes giving a driver a warning of the preset dangerous event.

15. The system of claim 14, wherein the data includes details of the warning and sensing results associated with the preset dangerous event.

16. The system of claim 11, wherein the controller is further configured to:
perform an intervening control to avoid the preset dangerous event while the vehicle is controlled in a driver driving mode; and
store, in the storage unit, i) a video of surroundings of the vehicle at the intervening control and ii) status information of the vehicle and data related to the intervening control in association with the video.

17. The system of claim 16, wherein the data related to the intervening control includes information on having given a driver a warning of the preset dangerous event.

18. The system of claim 16, wherein the status information includes one or more of i) information obtained by at least one light and ranging detection (LIDAR) module, ii) information obtained by at least one radar, or iii) information obtained by at least one ultrasonic sensor.

19. The system of claim 11, wherein the controller is further configured to store, in the storage unit, i) details of the autonomous driving control and sensor data while the vehicle is controlled in an autonomous driving mode and ii) a video of surroundings of the vehicle captured during the autonomous driving mode.

20. The system of claim 11, wherein the preset function includes warning a driver of the preset dangerous event while the vehicle is controlled in an autonomous driving mode.
